(19) United States
(12) Patent Application Publication
(10) Pub. No.: US 2021/0232466 A1
(43) Pub. Date: Jul. 29, 2021

(54) STORAGE SYSTEM AND RESTORE CONTROL METHOD

(71) Applicant: HITACHI, LTD., Tokyo (JP)

(72) Inventors: Takaki MATSUSHITA, Tokyo (JP); Tomohiro KAWAGUCHI, Tokyo (JP); Tadato NISHINA, Tokyo (JP); Yusuke YAMAGA, Tokyo (JP)

(73) Assignee: HITACHI, LTD., Tokyo (JP)

(21) Appl. No.: 17/006,095

(22) Filed: Aug. 28, 2020

(30) Foreign Application Priority Data
Jan. 27, 2020 (JP) 2020-010492

(51) Int. Cl. G06F 11/14; G06F 16/25; G06Q 10/10

(52) U.S. Cl. CPC G06F 11/1469; G06F 2201/84; G06Q 10/10; G06F 16/258

(57) ABSTRACT

A storage system includes a business volume, a controller, and an additional write volume. The controller manages first address conversion information for managing a relationship between addresses of the business volume and the additional write volume, and address conversion history information for managing a relationship between the addresses of the business volume and the additional write volume and a time when the data of the business volume is updated as history information. The controller acquires a snapshot of the business volume at each time the data amount of the address conversion history information reaches a predetermined threshold, and stores a recovery point to the address conversion history information at each time a recovery point set command is received for the business volume. Further, when receiving a restore command, the controller restores the business volume using the acquired snapshot and the recovery point stored in the address conversion history information.

### BACKGROUND OF THE INVENTION

### 1. Field of the Invention

The present invention relates to a storage system and a restore control method.

### 2. Description of the Related Art

When data is lost due to storage system failure or human error, or data is tampered with due to ransomware, it is required to restore the data from the backup as much as possible without data loss and to restore the normal state promptly. The storage administrator designs the time required for data restoration as RTO (Recovery Time Objective) and the objective when data is restored as RPO (Recovery Point Objective), and makes a backup plan.

A method of using a snapshot is known as a backup of data stored in the storage system. When data loss or data tampering occurs, it is possible to restore the past normal state by designating a snapshot and performing the restore. Japanese Patent No. 5657801 discloses CoW (Copy on Write) and CaW (Copy after Write) technologies as snapshot technologies. CoW is a technology that saves old data to another area in synchronization with write processing (update write) of data to the business volume to be protected. CaW is a technology that saves data to another area asynchronously to update write.

Further, as backup, CDP (Continuous Data Protection) technology is also known. CDP is a technology that can restore data to any specified point (recovery point) in the past. JP 2008-65503 A discloses a technology as a CDP technology, in which the history information of the update write is continuously stored, and when a failure or the like is detected, a recovery point that is a data recovery point is designated and data is restored from the history information.

### SUMMARY OF THE INVENTION

The CoW technology disclosed in Japanese Patent No. 5657801 requires saving the old data in synchronization with the write processing for the business volume to be protected, and has a problem that the performance of the business volume deteriorates. In particular, when the RPO is designed to be short in order to suppress data loss in the event of a data failure and snapshot acquisition is performed at short intervals, the response performance of the business volume constantly deteriorates. The CaW technology can suppress the deterioration of response performance, but it needs to save data as with CoW, and the problem that the throughput of the business volume deteriorates remains.

Further, the CDP disclosed in JP 2008-65503 A has a problem that the restoration time (RTO) becomes longer as the amount of history increases.

An object of the invention is to provide a storage system that reduces a restore processing time while suppressing the performance impact of the business volume.

According to one aspect of the storage system of the invention to solve the above problems, a storage system includes a controller for providing a business volume to a server system. The storage system includes an additional write volume for additionally writing and storing data stored in the business volume. The controller manages first address conversion information for managing a relationship between a logical address of the business volume and a logical address of the additional write volume, and an address conversion history information for managing a relationship between a logical address of the business volume and a logical address of the additional write volume for storing old data before the data of the business volume is updated, and managing a time when the data of the business volume is updated as history information.

At each time a data amount of the address conversion history information reaches a predetermined threshold, the controller determines a first target time indicating a timing of acquiring a snapshot of the business volume of the business volume. At each time a recovery point set command including a recovery point indicating a restore timing for the business volume is received, the controller stores a time when the recovery point set command is received together with the recovery point to the address conversion history information.

Further, when a restore command including information regarding the second target time indicating a restore timing and a restore destination volume for the business volume, the controller restores the business volume using the snapshot acquired at the first target time and the recovery point stored in the address conversion history information.

According to the invention, it is possible to reduce a restore processing time while suppressing the performance impact on a business volume.

### BRIEF DESCRIPTION OF THE DRAWINGS

FIG. 1 is a diagram illustrating a configuration example of a system including a storage system;

FIG. 2 is a diagram illustrating an example of a memory configuration, and programs and management information in a memory;

FIG. 3 is a diagram illustrating an example of a logical configuration in the storage system;

FIG. 4 is a diagram illustrating an example of a VOL/Snapshot management table;

FIG. 5 is a diagram illustrating an example of an address conversion table;

FIG. 6 is a diagram illustrating an example of an address update history table;

FIG. 7 is a diagram illustrating an example of a recovery point management table;

FIG. 8 is a diagram illustrating an example of a snapshot generation management table;

FIG. 9 is a diagram illustrating an example of a restore management table;

FIG. 10 is a diagram illustrating the flow of a read process;

FIG. 11 is a diagram illustrating the flow of a front-end write process;

FIG. 12 is a diagram illustrating the flow of a data reduction process;

FIG. 13 is a diagram illustrating the flow of an additional write process;

FIG. 14 is a diagram illustrating the flow of a recovery point setting process;

FIG. 15 is a diagram illustrating the flow of a snapshot generation process;

FIG. 16 is a diagram illustrating the flow of a snapshot generation/restore common process; and

FIG. 17 is a diagram illustrating the flow of a restore process.

### DESCRIPTION OF THE PREFERRED EMBODIMENTS

In the following description, “interface” may be configured by one or more interfaces. The one or more interfaces may be one or more communication interface devices of the same type (for example, one or more NICs (Network Interface Card)), or may be two or more communication interface devices of different types (for example, NIC and HBA (Host Bus Adapter)).

In addition, in the following description, “memory” may be configured by one or more memories, or may typically be a main storage device. At least one memory in the memory may be a volatile memory, or may be a non-volatile memory.

In addition, in the following description, “PDEV” may be one or more PDEVs, or may typically be an auxiliary storage device. The “PDEV” means a physical storage device, and typically is a non-volatile storage device such as an HDD (Hard Disk Drive) or an SSD (Solid State Drive). Alternatively, it may be a flash package.

The flash package is a storage device that includes a non-volatile storage medium. A configuration example of the flash package includes a controller and a flash memory that is a storage medium for storing write data from a computer system. The controller has a drive I/F, a processor, a memory, a flash I/F, and a logic circuit having a compression function, which are interconnected via an internal network. The compression function may be omitted.

Further, in the following description, a “storage unit” is at least one of a memory and a PDEV (typically at least a memory).

In addition, in the following description, a “processing unit” is configured by one or more processors. At least one processor is typically a microprocessor such as a CPU (Central Processing Unit), or may be other types of processors such as a GPU (Graphics Processing Unit). At least one processing unit may be configured by a single core, or multiple cores.

In addition, at least one processor may be a processor such as a hardware circuit (for example, FPGA (Field-Programmable Gate Array) or an ASIC (Application Specific Integrated Circuit)) which performs some or all of the processes in a broad sense.

In addition, in the following description, information for obtaining an output with respect to an input will be described using an expression of “xxx table”. The information may be data of any structure, or may be a learning model such as a neural network in which an output with respect to an input is generated. Therefore, the “xxx table” can be called “xxx information”.

In addition, in the following description, the configuration of each table is given as merely exemplary. One table may be divided into two or more tables, or all or some of two or more tables may be configured by one table.

In addition, in the following description, a process may be described using the word “program” as a subject. The program is performed by the processing unit, and a designated process is performed appropriately using a storage unit and/or an interface. Therefore, the subject of the process may be the processing unit (or a device such as a controller which includes the processor).

The program may be installed in a device such as a calculator, or may be, for example, a program distribution server or a (for example, non-temporary) recording medium which can be read by a calculator. In addition, in the following description, two or more programs may be expressed as one program, or one program may be expressed as two or more programs.

In addition, in the following description, a “computer system” is a system which includes one or more physical calculators. The physical calculator may be a general purpose calculator or a dedicated calculator. The physical calculator may serve as a calculator (for example, a host computer or a server system) which issues an I/O (Input/Output) request, or may serve as a calculator (for example, a storage device) which inputs or outputs data in response to an I/O request.

In other words, the computer system may be at least one of one or more server systems which issue the I/O request, and a storage system which is one or more storage devices for inputting or outputting data in response to the I/O request. In at least one physical calculator, one or more virtual calculators (for example, VM (Virtual Machine)) may be performed. The virtual calculator may be calculator which issues an I/O request, or may be a calculator which inputs or outputs data in response to an I/O request.

In addition, the computer system may be a distribution system which is configured by one or more (typically, plural) physical node devices. The physical node device is a physical calculator.

In addition, SDx (Software-Defined anything) may be established in the physical calculator (for example, a node device) or the computer system which includes the physical calculator by performing predetermined software in the physical calculator. Examples of the SDx may include an SDS (Software Defined Storage) or an SDDC (Software-defined Datacenter).

For example, the storage system as an SDS may be established by a general-purpose physical calculator which performs software having a storage function.

In addition, at least one physical calculator (for example, a storage device) may be configured by one or more virtual calculators as a server system and a virtual calculator as the storage controller (typically, a device which inputs or outputs data with respect to the PDEV in response to the I/O request) of the storage system.

In other words, at least one such physical calculator may have both a function as at least a part of the server system and a function as at least a part of the storage system.

In addition, the computer system (typically, the storage system) may include a redundant configuration group. The redundant configuration may be configured by Erasure Coding, RAIN (Redundant Array of Independent Nodes) and a plurality of node devices such as mirroring between nodes, or may be configured by a single calculator (for example, the node device) such as one or more RAID (Redundant Array of Independent (or Inexpensive) Disks) groups as at least a part of the PDEV.

In addition, in the following description, identification numbers are used as identification information of various types of targets. Identification information (for example, an identifier containing alphanumeric characters and symbols) other than the identification number may be employed.

In addition, in the following description, in a case where similar types of elements are described without distinction, the reference symbols (or common symbol among the reference symbols) may be used. In a case where the similar elements are described distinctively, the identification numbers (or the reference symbols) of the elements may be used.

### First Embodiment

Hereinafter, a first embodiment will be described with reference to the drawings.

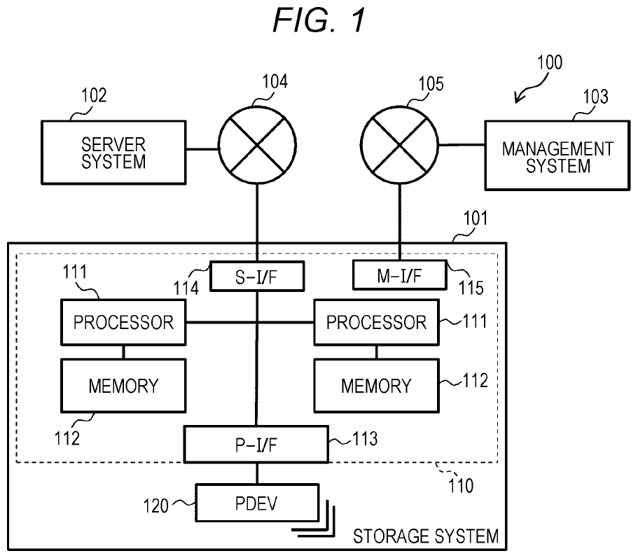

FIG. 1 is a diagram illustrating an example of the configuration of a computer system 100.

The computer system 100 includes a storage system 101, a server system 102, a management system 103, and a network. The storage system 101 and the server system 102 are connected via an FC (Fibre Channel) network 104. The storage system 101 and the management system 103 are connected via an IP (Internet Protocol) network 105. The FC network 104 and the IP network 105 are not limited to this, and may be the same communication network, for example.

The storage system 101 includes one or more storage controllers 110 (hereinafter may be referred to as controllers) and one or more PDEVs 120. The PDEV 120 is connected to the storage controller 110.

The storage controller 110 includes one or more processors 111, one or more memories 112, a P-I/F 113, an S-I/F 114, and an M-I/F 115.

The processor 111 is an example of a processing unit. Further, the processor 111 may include a hardware circuit which performs compression and expansion. In this embodiment, the processor 111 executes a program, and performs a read and write process, a restore process, a compression and decompression process, and the like.

The memory 112 is an example of the storage unit. The memory 112 stores programs executed by the processor 111, data used by the processor 111, and the like. The processor 111 executes the program stored in the memory 112. In this embodiment, for example, the set of the memory 112 and the processor 111 is duplicated.

The P-I/F 113, the S-I/F 114, and the M-I/F 115 are examples of interfaces.

The P-I/F 113 is a communication interface device which relays exchanging data between the PDEV 120 and the storage controller 110. A plurality of PDEVs 120 are connected to the P-I/F 113.

The S-I/F 114 is a communication interface device which relays exchanging data between the server system 102 and the storage controller 110. The server system 102 is connected to the S-I/F 114 via the FC network 104.

The M-I/F 115 is a communication interface device which relays exchanging data between the management system 103 and the storage controller 110. The management system 103 is connected to the M-I/F 115 via the IP network 105.

The server system 102 is configured to include one or more host devices. The server system 102 (host device) transmits an I/O request (write request or read request), which is designated with an I/O destination (for example, a logical volume number such as a LUN (Logical Unit Number) and a logical address such as an LBA (Logical Block Address)), to the storage controller 110.

The management system 103 is configured to include one or more management devices. The management system 103 manages the storage system 101.

The PDEV 120 is typically an auxiliary storage device. The “PDEV” means a physical storage device which is a storage device, and typically is a non-volatile storage device such as an HDD (Hard Disk Drive) or an SSD (Solid State Drive). Alternatively, it may be a flash package.

Although one embodiment has been described above, this is merely an example, and the scope of the invention is not limited to this embodiment.

The invention can be implemented in other various forms. For example, although the transmission source (I/O source) of an I/O request such as a write request is the server system 102 in the above-described embodiment, a program (for example, an application program executed on a VM; not illustrated) in the storage system 101 may be used.

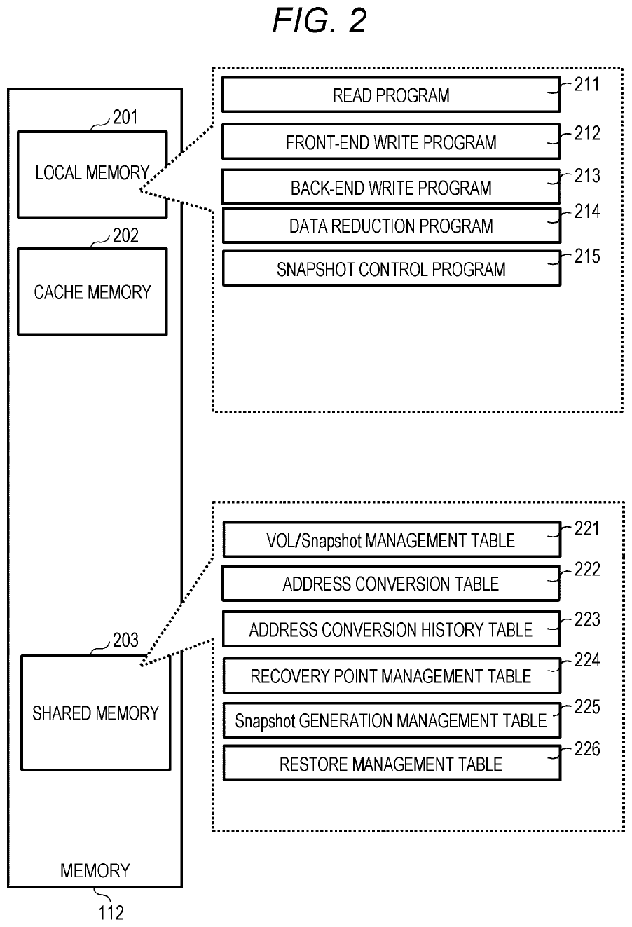

FIG. 2 is a diagram illustrating an example of the configuration of the memory 112, and programs and management information in the memory 112. The memory 112 includes memory regions of a local memory 201, a cache memory 202, and a shared memory 203. At least one of these memory regions may be an independent memory. The local memory 201 is used in the storage controller by the processor 111 which belongs to the same group as the memory 112 which includes the local memory 201.

The local memory 201 stores a read program 211, a front-end write program 212, a back-end write program 213, a data amount reduction program 214, and a snapshot control program 215. These programs will be described below.

In the cache memory 202, the data set written or read with respect to the PDEV 220 is stored temporarily.

In the storage controller, the shared memory 203 is used by both the processor 111 belonging to the same group as the memory 112 which includes the shared memory 203, and the processor 111 belonging to a different group. The management information is stored in the shared memory 203.

The management information includes a VOL/Snapshot management table 221, an address conversion table 222, an address conversion history table 223, a recovery point management table 224, a snapshot generation management table 225, and a restore management table 226.

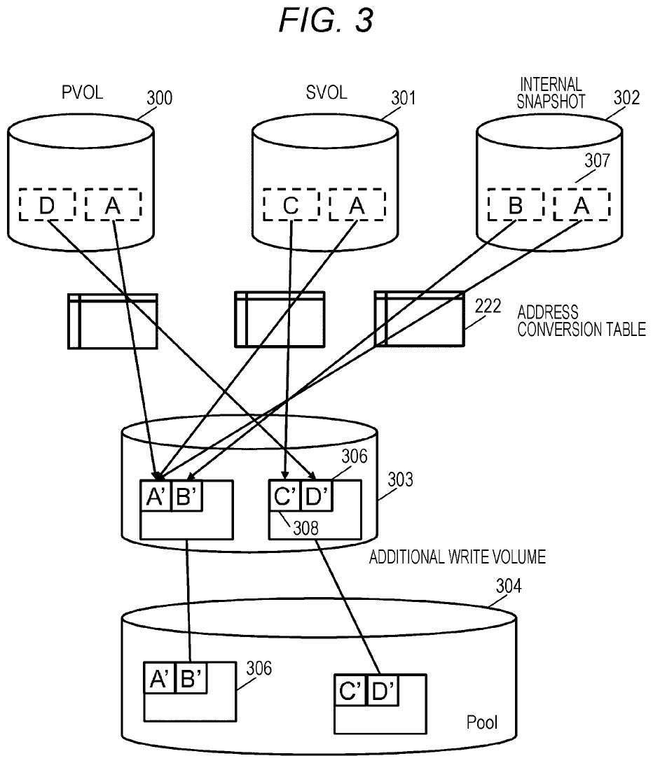

FIG. 3 is a diagram illustrating an example of a logical configuration within the storage system 101. The storage system 101 includes a logical configuration such as a PVOL 300, an SVOL 301, an internal snapshot 302, an additional write volume 303, and a pool 304. The storage system 101 also manages the address conversion table 222 corresponding to the PVOL 300, the SVOL 301, and the internal snapshot 302.

The PVOL 300 is a logical volume (business volume) that is provided in the server system 102 and in which the server system 102 writes data.

The SVOL 301 is a volume obtained by restoring the data of the PVOL 300 at the past time point (called a recovery point) set by the server system 102 or the management system 103.

Like the SVOL 301, the internal snapshot 302 is also a volume obtained by restoring the past time point of the PVOL 300, but it is not a volume created by an instruction from the server system 102 or the management system 103, but a volume internally created by the storage system 101.

The additional write volume 303 is a logical volume for additional writing. One or more PVOLs 300, SVOLs 301, and internal snapshots 302 are associated with one additional write volume 303. For example, when the storage system 101 receives the update data for the logical address of one PVOL, the additional write volume 303 stores a logical address different from the storage location of old data of the additional write volume while holding the old data rewritten with the update data.

The pool 304 is a logical storage area based on one or more RAID groups (not illustrated). The pool 304 is configured by a plurality of pages 306.

The page 306 is allocated to the additional write volume 303 from the pool 304 according to the writing of data.

The storage controller 110 divides the write data received from the server system 102 into fixed length data sets 307, and compresses the data sets 307 as a unit.

The additional write volume 303 is additionally written to the page 306 to which the compressed data set is allocated. In the following description, the area occupied by the compressed data set in the page 306 is referred to as “sub block 308”.

The address conversion table 222 is provided for each of the PVOL 300, the SVOL 301, and the internal snapshot 302. The address conversion table 222 is a table that holds the correspondence relationship between the logical addresses of the PVOL 300, SVOL 301, and the internal snapshot 302 and the logical address of the additional write volume 303.

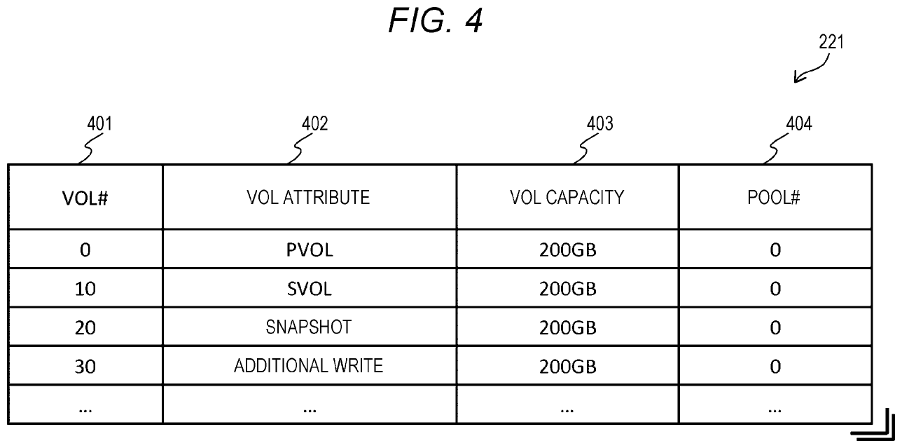

FIG. 4 is a diagram illustrating an example of the VOL/Snapshot management table 221. In this embodiment, information on the logical volume provided to the server system 102, such as the PVOL 300 and the SVOL 301, and information on the logical volume not provided to the server system 102, such as the internal snapshot 302 and the additional write volume 303, are also managed by the VOL/Snapshot management table 221. Each volume is created by the storage controller 110 in response to a volume creation instruction from the management system 103, for example. The created volume is managed by the VOL/Snapshot management table 221.

The VOL/Snapshot management table 221 holds information about VOL or Snapshot. The VOL/Snapshot management table 221 has an entry for each VOL. Each entry stores a VOL #401, a VOL attribute 402, a VOL capacity 403, and a pool #404.

The VOL #401 is information on the number (identification number) of the VOL or the internal snapshot.

The VOL attribute 402 is attribute information of the VOL or the internal snapshot. For example, the PVOL is held as “PVOL”, the SVOL is held as “SVOL”, the internal snapshot is held as “Snapshot”, and the additional write volume is held as “additional write”.

The VOL capacity 403 is information on the logical capacity of the VOL or the internal snapshot.

A pool #404 is information on pool number for identifying the pool associated with the VOL.

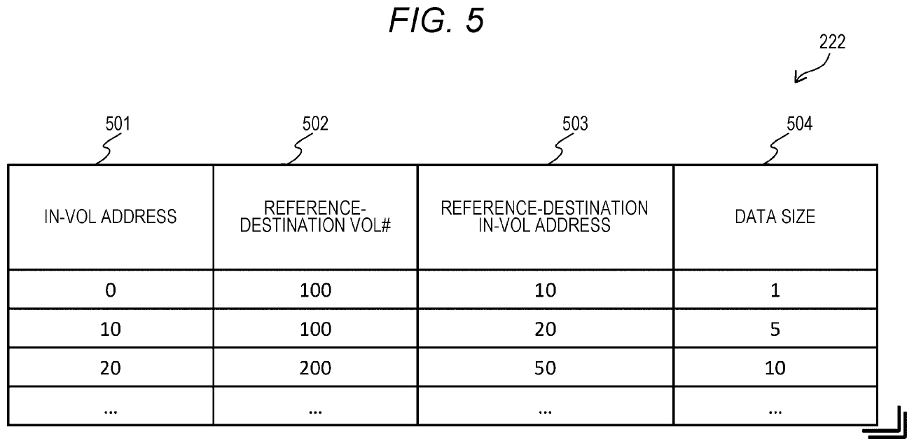

FIG. 5 is a diagram illustrating an example of the address conversion table 222. The address conversion table 222 is prepared for each of the PVOL 300, the SVOL 301, and the internal snapshot 302. The address conversion table 222 holds and manages information regarding the relationship between the reference-source logical address (the logical addresses of the PVOL 300, the SVOL 301, and the internal snapshot 302) and the reference-destination logical address (the logical address of the additional write volume 303).

For example, the address conversion table 222 has an entry for each fixed length data set 307. Each entry stores information such as an in-VOL address 501, a reference-destination VOL #502, a reference-destination in-VOL address 503, and a data size 504.

The in-VOL address 501 is information of the logical address of the fixed-length data set in the PVOL 300, the SVOL 301, and the internal snapshot 302. The reference-destination VOL #502 is information for identifying the reference-destination VOL (additional write volume) of the data set.

The reference-destination in-VOL address 503 is information of the logical address in the reference-destination VOL (additional write volume 303) of the data set.

The data size 504 is information of the size of the compressed data set.

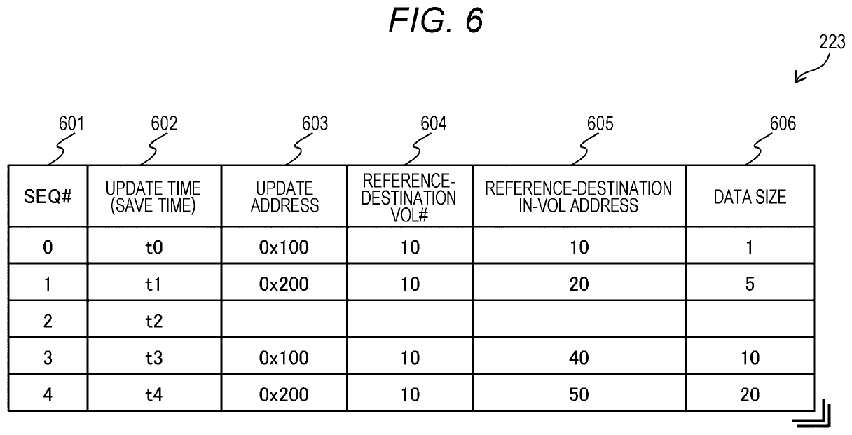

FIG. 6 is a diagram illustrating an example of the address conversion history table 223. The address conversion history table 223 is set for the PVOL 300 or the SVOL 301.

When the address conversion table 222 of the PVOL 300 or the SVOL 301 is updated in the address conversion history table 223, a new entry is added to the table. For example, when the relationship between the address of the PVOL 300 and the address of the additional write volume that is the reference-destination VOL is updated by an update write to the PVOL 300, a new entry is added to the address conversion history table 223.

The address conversion history table 223 stores an SEQ #601, a time when the entry of the address conversion table 222 is saved (save time 602), a logical address in the PVOL regarding the update data (update address 603), a reference-destination VOL #604, a reference-destination in-VOL address 605, and a data size 606.

The SEQ #601 is a sequence number for managing the write order allocated to the PVOL 300 when writing, and is information given to the update write.

The save time 602 is the time when the data of the PVOL 300 or the SVOL 301 is updated (the time when the entry of the address conversion table 222 is saved by the update data). t0 is the oldest, and t4 is the newest time.

The update address 603 is the same information as the in-VOL address 501 of the entry to be saved in the address conversion table 222, and is the logical address of the PVOL 300 or the like provided to the server system 102.

The reference-destination VOL #604, the reference-destination in-VOL address 605, and the data size 606 are also the same information as the reference-destination VOL #502, the reference-destination in-VOL address 503, and the data size 504 of the entry related to the old data that has been the save target of the address conversion table 222. That is, the reference-destination VOL #604, the reference-destination in-VOL address 605, and the data size 606 are information related to the address in the additional write volume that stores the old data that is the saved data.

The address conversion history table 223 of FIG. 6 manages the correspondence among the update address 603 which is the logical address of the PVOL 300, the reference-destination VOL #604 that specifies an additional write volume indicating the storage destination of the old data, the reference-destination in-VOL address 605, and the data size 606 with respect to the data which becomes the old data by update data in the PVOL 300.

With this configuration, it is possible to manage the relationship between the storage destination of the old data saved by the update data for the PVOL 300 and the logical address in the PVOL 300 of the update data.

The address conversion history table 223 stores entries in the order of the SEQ #.

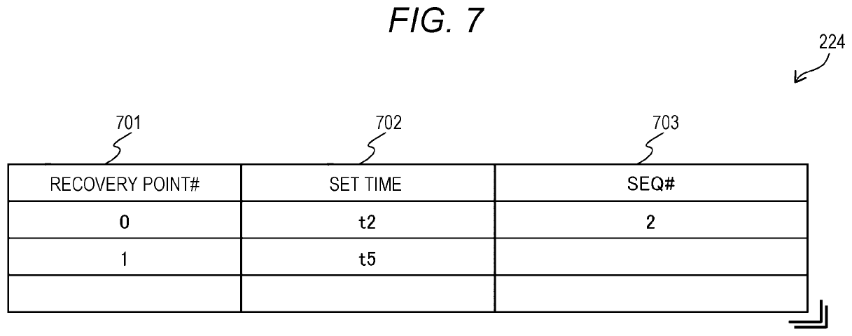

FIG. 7 is a diagram illustrating an example of the recovery point management table 224. The recovery point management table 224 is set for the PVOL 300 or the SVOL 301.

Each entry of the recovery point management table 224 is added every time a recovery point set command is received from the server system 102 or the management system 103. The recovery point set command includes the volume (PVOL etc.) to be restored.

Each entry of the recovery point management table 224 stores information of a recovery point #701, a recovery point set time (hereinafter, set time 702), and an SEQ #703.

The recovery point #701 is a number serving as identification information for uniquely determining the set recovery point.

The set time 702 is the time when the recovery point set command is received.

The SEQ #703 is information common to the SEQ #601 held in the address conversion history table 223, and is a sequence number for managing the order of write and recovery point set commands. The SEQ #601 corresponding to the save time 602 of FIG. 6 that is the same time as the set time 702 of FIG. 7 is set to the SEQ #703. For example, when the recovery point #701 is “0”, the set time is “t2”. Therefore, “2” is stored in the SEQ #601 after the save time t1 of the address conversion history table 223, and the same value “2” is stored in the SEQ #703.

The information of the recovery point management table 224 of FIG. 7 is provided from the storage controller 110 to the management system 103. From the management system 103, the recovery point #701 of the recovery point management table 224 can be designated as the time when the PVOL is restored. The information of the recovery point management table 224 of FIG. 7 may be provided to the server system 102 as well.

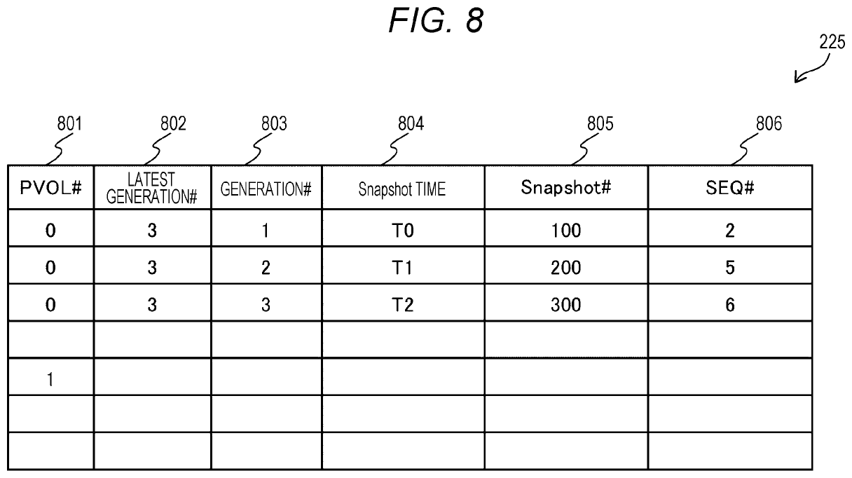

FIG. 8 is a diagram for describing the snapshot generation management table 225.

The snapshot generation management table 225 manages the PVOL 300 and the snapshot acquired for the PVOL 300. The snapshot generation management table 225 manages the entry associated with a PVOL number (PVOL #801), a latest generation number (latest generation #802), a generation number (generation #803), a snapshot time 804, a snapshot number (snapshot #805), and an SEQ #806.

The PVOL #801 is a number that uniquely identifies the PVOL in the storage device.

The latest generation #802 is the generation number of the latest internal snapshot in the corresponding PVOL. Since the latest generation #802 is “3” when the PVOL #801 is “0”, the snapshots are acquired over three generations.

The generation #803 is a snapshot generation number, and is information used to specify the old and new relationships between snapshots. The generation #803 is “1” when the PVOL #801 is “0” indicates that it is the oldest generation of the snapshots acquired over three generations.

The snapshot time 804 is time information for identifying at what time point the PVOL state represents the snapshot. In this embodiment, the snapshot is generated asynchronously, that is, at an arbitrary timing within the storage device, not by a request from the management system 103 or the server system 102. Therefore, the snapshot time 804 is different from the time when the snapshot is generated.

The snapshot #805 is a number that uniquely identifies the relationship between the PVOL and the snapshot, and is, for example, identification information such as a serial number for each PVOL.

As will be described later, the SEQ #806 is information for specifying the SEQ # of the update data near the snapshot time. The SEQ #806 is a start point for searching history information of the address conversion history table 223 when a restore instruction is given.

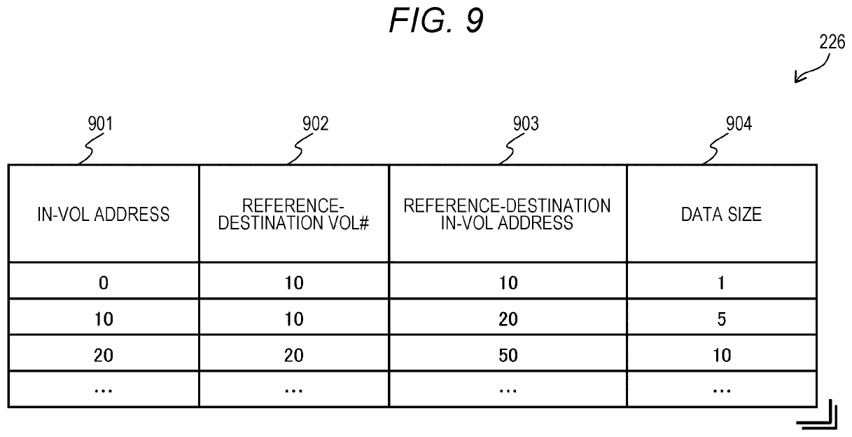

FIG. 9 is a diagram for describing the restore management table 226. The restore management table 226 is managed in units of the PVOL 300 or the SVOL 301 and stores the search result of the entry to be restored from the entries (address conversion information) saved in the address conversion history table 223.

When a restore command designating a recovery point # is received from the server system 102 or the management system 103, the address conversion information necessary for recovering the data at the designated recovery point is managed. The restore command includes a volume # to be restored and a recovery point #.

For example, when “0” for the recovery point #701 is designated to the PVOL 300 by the management system 103 as the time to be restored, “t2” for the set time 702 and “2” for SEQ #703 corresponding to “0” of the recovery point #701 are read from the recovery point management table 224. In order to acquire the image of the PVOL 300 when the recovery point #701 is “0”, information (the update address 603, the reference-destination VOL #604, the reference-destination in-VOL address 605, the data size 606) corresponding to SEQ # “1” which is the entry before the entry of “t2” of the save time 602 corresponding to “2” of SEQ #703 is acquired from the address conversion history table 223, and set in the restore management table 226. As described above, the restore management table 226 manages an in-VOL address 901 of the PVOL 300, a reference-destination VOL #902 which corresponds to the in-VOL address 901 at the recovery point and is the storage location of the data “1” of the SEQ #601, a reference-destination in-VOL address 903, and a data size 904 in association with each other.

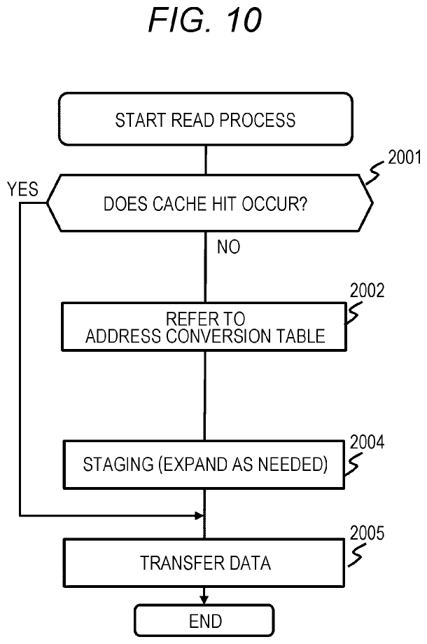

FIG. 10 is a diagram illustrating an example of the flow of a read process. The read process is performed when a read request for the PVOL 300 or the SVOL 301 is received.

The read program 211 determines whether the data of the address for which the read request is received exists in the cache memory 202 (Step S2001).

When the determination of Step S2001 is true (when a cache hit occurs), the process proceeds to Step S2005.

When the determination of Step S2001 is false (when a cache miss occurs), the address conversion table 222 of the PVOL 300 or the SVOL 301 is referenced (Step 2002).

The read program 211 specifies the reference-destination in-VOL address 503 and the data size 504 based on the address conversion table 222 (Step 2002).

The read program 211 specifies the storage page of the read target data from the specified reference-destination in-VOL address 503, reads the compressed data set from the specified page, expands the compressed data set, and stores the expanded data set in the cache memory 202 (Step 2004).

The read program 211 transfers the data stored in the cache memory to the issuer of the read request (Step S2005).

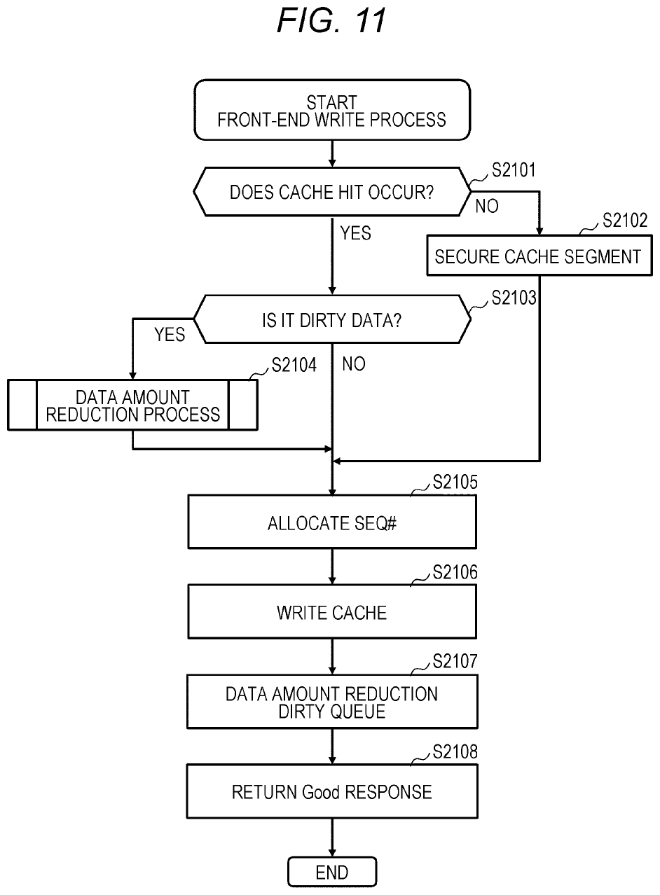

FIG. 11 is a diagram illustrating an example of the flow of a front-end write process. The front-end write process is performed when a write request for a VOL (for example, business volume 300) is received.

The front-end write program 212 determines whether a cache hit has occurred (Step S2101). Regarding the write request, “cache hit” means that the cache segment (an area in the cache memory 202) corresponding to the write destination according to the write request is secured.

When the determination result of Step S2101 is false (Step S2101: NO), the front-end write program 212 secures the cache segment from the cache memory 202 (Step S2102).

When the determination result of Step S2101 is true (Step S2101: YES), the front-end write program 212 determines whether the data of the cache segment is dirty data (Step S2103). The “dirty data” means data stored in the cache memory 202 and not stored in the PDEV 120. That is, the data is written before the current write request.

When the determination result of Step S2103 is true (Step S2103: YES), the front-end write program 212 performs a data amount reduction process on the dirty data (Step S2104).

When the determination result of Step S2103 is false (Step S2103: NO), or when the process of Step S2102 or Step S2104 is performed, the front-end write program 212 gives the SEQ # corresponding to the write request of this time (Step S2105).

Then, the front-end write program 212 writes the write target data according to the write request of this time into the secured cache segment (Step S2106).

Subsequently, the front-end write program 212 accumulates the write command for each of the one or more data sets forming the write target data in a data amount reduction dirty queue (Step S2107).

The “data amount reduction dirty queue” is a queue for accumulating write commands for a data set that is dirty (data set that is not stored in a page) and is required to be compressed.

Then, the front-end write program 212 returns a GOOD response (write completion report) to the transmission source of the write request (Step S2108). The GOOD response to the write request may be returned when a back-end write process is completed.

The back-end write process for writing from the storage controller 110 to the PDEV 120 may be performed synchronously or asynchronously with the front-end process. The back-end write process is performed by a back-end write program 213. If the data compression process is not performed, Step S2104 is not necessary.

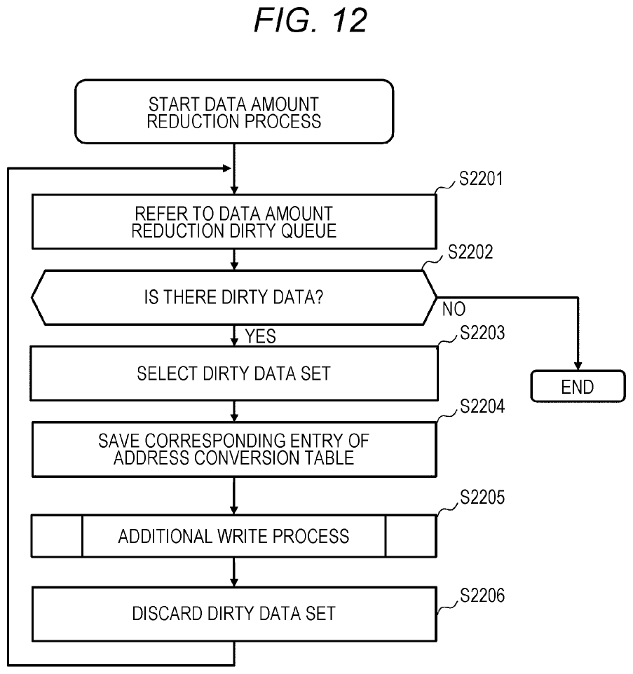

FIG. 12 is a diagram illustrating an example of the flow of the data amount reduction process. The data amount reduction process is performed by a data amount reduction program 214, for example. The data amount reduction process may be performed, for example, periodically. The data amount reduction process is not an essential process in this embodiment when data compression is not performed, and thus the flow of the process will be briefly described.

The data amount reduction program 214 refers to the data amount reduction dirty queue (Step S2201), and determines whether there is a command in the data amount reduction dirty queue (Step S2202). If the determination result is false (Step S2202: NO), the data amount reduction process ends.

When the determination result of Step S2202 is true (Step S2202: YES), the data amount reduction program 214 refers to the data amount reduction dirty queue and selects the dirty data set (Step S2203).

Subsequently, the data amount reduction program 214 saves the corresponding entry information of the address conversion table 222 (Step S2204). More specifically, the data amount reduction program 214 sets the SEQ # corresponding to the dirty data set secured in Step 2105 of the front-end write process to the SEQ #601, and sets the current time to the save time 602. When the data amount reduction process is not performed, the SEQ #601 may be set when the update data is written to the PDEV.

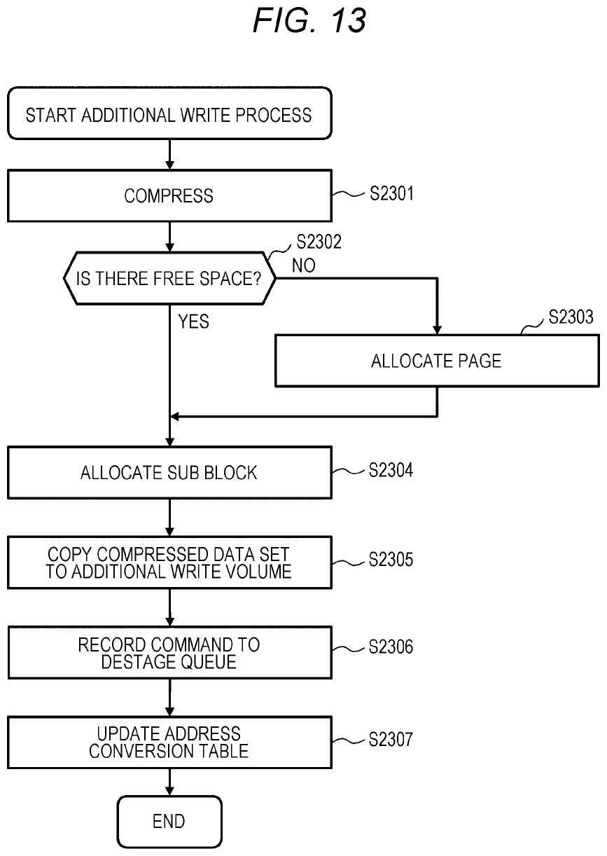

Subsequently, the data amount reduction program 214 performs an additional write process on the dirty data set (Step S2205). The additional write process will be described later with reference to FIG. 13.

When the additional write process is completed, the data amount reduction program 214 discards the dirty data set selected in Step S2203 (for example, deletes the dirty data from the cache memory 202) (Step S2206), and the process proceeds to Step S2201.

FIG. 13 is a diagram illustrating an example of the flow of the additional write process. The data amount reduction program 214 compresses the write data set and stores the compressed data set in, for example, a local memory 301 (Step S2301). If the data compression is not performed, Step S2301 is not necessary and is skipped.

The data amount reduction program 214 determines whether there is a free space equal to or larger than the size of the compressed data set in the page 461 already allocated to the additional write volume 303 corresponding to the write destination volume (Step S2302).

In order to make this determination, for example, a logical address registered as the information of the additional write destination address corresponding to the additional write volume 303 may be specified, and a sub block management table corresponding to the additional write volume 303 may be referred using the page number allocated to the area to which the specified logical address belongs as a key.

When the determination result of Step S2302 is false (Step S2302: NO), the data amount reduction program 214 allocates an unallocated page to the additional write volume 303 corresponding to the write destination volume (Step S2303).

When the determination result of Step S2302 is true (Step S2302: YES), or after the process of Step S2303 is performed, the data amount reduction program 214 allocates a sub block as an additional recording destination (Step S2304).

The data amount reduction program 214 copies the compressed data set of the write data set to the additional write volume 303, for example, copies the compressed data set to the area for the additional write volume 303 (an area in the cache memory 202) (Step S2305).

The data amount reduction program 214 registers the write command of the compressed data set in a destage queue (Step S2306), and updates the address conversion table 222 corresponding to the write destination volume (Step S2307).

By updating this address conversion table 222, the information of the reference-destination VOL #902 corresponding to the write destination block and the information of the reference-destination in-VOL address 903 are changed to the number of the additional write volume 303 and the logical address of the sub block 702 assigned in the Step S2304.

When the data amount reduction process is not performed, in the data amount reduction process S2104 of FIG. 11, the change (S2307) of the address conversion table is performed to manage the relationship between the logical address for storing the old data of the PVOL 300 and the logical address of the additional write volume 303 for storing the updated data.

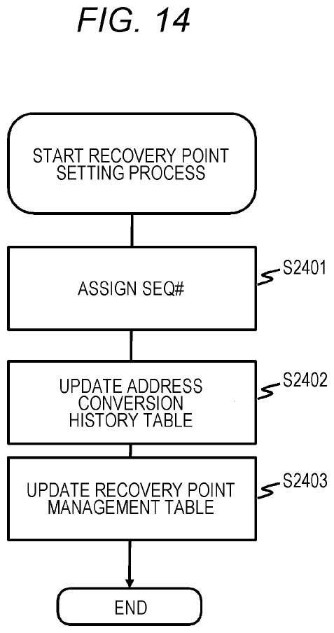

FIG. 14 is a diagram illustrating an example of the flow of a recovery point setting process. Recovery point setting is started from the management system 103 or the server system 102 by a recovery point set command including VOL # information. The recovery point set command includes the VOL # of the volume to be restored in order to set the timing to restore the volume as the recovery reception timing.

When the storage controller 110 receives the recovery point set command, VOL # of the restore target volume and the information indicating a recovery point reception timing can be managed in the recovery point management table 224 using a small amount of information such as the recovery point #701, the set time 702, and the SEQ #703. Therefore, many recovery points can be created independently of the creation of the snapshot generated by the storage controller 110, according to the status of the application on the server system 102. The recovery point set command can be issued at a meaningful point according to the application, such as at the time of storing a file if the application on the server system 102 is a file system, and at the time of ending transaction if the application is a database.

The recovery point setting process is executed by the snapshot control program 215 according to a recovery point set command from the server system 102 or the management system 103, for example.

When receiving the recovery point set command, the snapshot control program 215 assigns the SEQ # to the received recovery point set command (Step S2401).

Next, the snapshot control program 215 adds the entry of the assigned SEQ # to the address conversion history table 223 (Step S2402). Specifically, the SEQ # assigned in Step S2401 is set in the SEQ #601 of the address conversion history table 223. Further, the time when the recovery point set command is received is set to the save time 602. The update address 603, the reference-destination VOL #604, the reference-destination in-VOL address 605, and the data size 606 may remain unset at this stage.

Next, the snapshot control program 215 adds an entry to the recovery point management table 224 (Step S2403). Specifically, the recovery point # is set to the recovery point #701 in response to the received recovery point set command. Further, the time when the recovery point set command is received is set to the set time 702. The set time 702 is the same as the save time 602 set in the address conversion history table 223 in Step S2402. In addition, in Step S2401, the SEQ # assigned to the recovery point set command is set to the SEQ #703.

By the process illustrated in FIG. 14, the entries of the address conversion history table 223 (FIG. 6) and the recovery point management table 224 (FIG. 7) are updated in response to the reception of the recovery point set command.

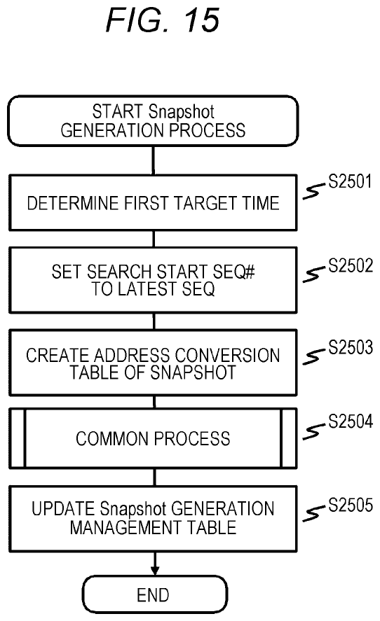

FIG. 15 is a diagram illustrating an example of the flow of a snapshot generation process. In the snapshot generation process, the snapshot control program 215 executes the process autonomously by the storage controller 110 according to the amount of history data stored in the address conversion history table 223, for example. If the time required for restoration (RTO) required by the user is relatively short, more snapshots are generated, and if the RTO is relatively long, a smaller number of snapshots are generated. In this way, the snapshot is generated according to the required RTO and according to the amount of history data stored in the address conversion history table 223, without receiving an instruction from the outside to the storage controller 110.

The snapshot control program 215 first determines a first target time, which is the time when the snapshot is generated (Step S2501). If many entries (history information) in the address conversion history table 223 are processed for restoration, it takes a lot of time. Therefore, a snapshot is generated from the RTO required for each volume so that the time required for restoration (RTO) is satisfied. The time at which a snapshot required to keep this history information below or equal to a certain amount is generated is determined as the first target time. For example, in a case where it is determined that the time to refer to the entry amount saved in the address conversion history table 223 by the write that has occurred after the latest snapshot time (for example, T2 of the snapshot time 804 in FIG. 8) at that time exceeds the requested RTO, the time of the entry (the save time 602 in FIG. 6) when falling into the RTO may be set as the first target time.

The first target time is not the time when the snapshot is generated, but the time when the generated snapshot represents the state of the PVOL. This is because the snapshot is generated asynchronously with the I/O processing from the server system 102. That is, the PVOL 300 can receive the I/O from the server system 102 even during the snapshot generation.

The first target time is, for example, the time when the number of entries stored in the address conversion history table 223 from that time to the latest recovery point that has been set reaches a certain threshold. That is, the first target time may be determined as a timing for generating the snapshot of the business volume 300 at each time the data amount of the address conversion history table 223 reaches a predetermined threshold.

Next, the snapshot control program 215 refers to the address conversion history table 223, acquires the latest SEQ #, and sets the latest SEQ # as a search start SEQ # (Step S2502).

The search start SEQ # is the SEQ # that starts the search when searching the address conversion history table 223 starts in the snapshot generation/restore common process described later.

Next, the snapshot control program 215 creates the address conversion table 222 of the generated snapshot (Step S2503). This is because the correspondence between the logical addresses of the snapshot 302 and the additional write volume 303 is managed so that the snapshot data can be accessed.

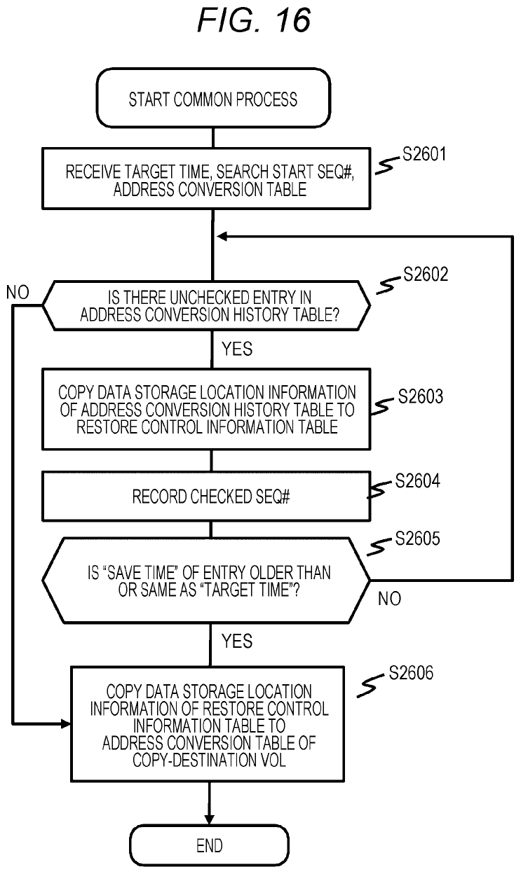

Next, the snapshot control program 215 creates a snapshot by executing the snapshot generation/restore common process (Step S2504). Details of the process will be described with reference to FIG. 16.

Finally, the snapshot control program 215 stores the snapshot information generated in the snapshot generation management table 225 (Step S2506). In this step, the PVOL #801, the latest generation #802, the generation #803, the snapshot time 804, the snapshot #805, and the SEQ #806 of the snapshot generation management table 225 are updated. The SEQ #806 is the SEQ # checked at the end of the address conversion history table 223 stored in Step S2604 of FIG. 16 described later, and is the SEQ # older than the target time and closest to the target time.

FIG. 16 is a diagram illustrating an example of the flow of the snapshot generation/restore common process.

The common process is executed by the snapshot control program 215, for example, when a snapshot generation/restore process is triggered.

The snapshot control program 215 receives the “first target time” of Step S2501, or the “second target time” indicating the time when it is desired to restore from the server system 102 or the management system 103, the “search start SEQ #” of Step S2502, and the “address conversion table” of the snapshot of Step S2503 as the information determined in the pre-processing (Step S2601). In FIG. 16, the first target time and the second target time are simply represented as a target time. When a restore instruction is received from the server system 102 or the management system 103, the target time of Step S2601 of FIG. 16 is the second target time. Further, when the snapshot control program 215 executes Step S2504 of the snapshot generation process of FIG. 15, the target time of Step S2601 of FIG. 16 is the first target time.

The second target time is the set time 702 specified by referring to the recovery point management table 224 when the restore command (including the recovery point #) is received from the server system 102 or the management system 103.

Next, the snapshot control program 215 starts checking from the entry of the “search start SEQ #” in the address conversion history table 223 in the order of the SEQ # in the old direction. If there are no more entries to check (Step S2602: NO), the process proceeds to Step S2606. This is to confirm whether the entry to be processed for restoration is in the address conversion history table.

If there is still an entry to be checked (Step S2602: YES), the data storage location information of the address conversion history table 223 is copied to the restore management table 226 (Step S2603). Specifically, for the entry of the in-VOL address 901 of the restore management table 226 corresponding to the update address 603 of the address conversion history table 223, the reference-destination VOL #604, the reference-destination in-VOL address 605, and the data size 606 of the address conversion history table 223 are copied to the reference-destination VOL #902, the reference-destination in-VOL address 903, and the data size 904 of the restore management table 226, respectively. Thereby, the address information in the additional write volume 303 of the old data corresponding to the checked SEQ #601 can be managed by the restore management table 226.

Next, the snapshot control program 215 stores the checked SEQ #601. Although not illustrated, it is stored in any area in the memory (Step S2604).

Next, the snapshot control program 215 determines whether the save time 602 of the checked entry is older than or equal to the “target time” received in Step S2601. This is to determine whether there is the SEQ # having an old save time to be checked. At this time, the first target time is used when generating the snapshot, and the second target time is used when performing the restore process. When the determination result is false (Step S2605: NO), it is determined that the entry to be checked still exists, and the process proceeds to Step S2602. When the determination result is true (Step S2605: YES), it is determined that there is no entry to be checked, and the process proceeds to Step S2606. The fact that there is no entry to be checked means that the save destination address information of the old data for restoring the data at the target time has been specified, and this save destination address information is stored as the reference-destination VOL #902, the reference-destination in-VOL address 903, and the data size 904 of the restore management table 226.

In Step S2606, a copy destination address conversion table is generated using the created restore management table 226. Specifically, the reference-destination VOL #902, the reference-destination in-VOL address 903, and the data size 904 corresponding to the in-VOL address 901 of the restore management table 226 are respectively copied to the reference-destination VOL #502, the reference-destination in-VOL address 503, and the data size 504 of the address conversion table 222. As a result, the address conversion table 222 that reproduces the state of the target time received in Step S2601 is created.

In the process of FIG. 16, by checking the entries of the address conversion history table in the order from the search start SEQ #, it is possible to copy the correspondence between the storage location (the logical address of the additional write volume 303) of the old data and the logical address of the PVOL to the address conversion table of the copy destination in order to reproduce the image of the PVOL at the target time (the first and second target times).

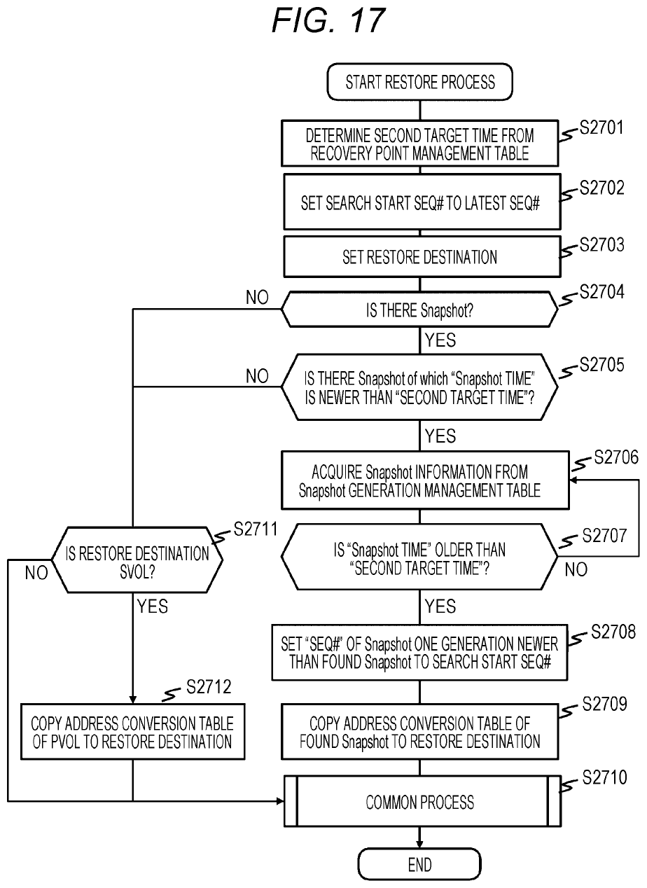

FIG. 17 is a diagram illustrating an example of the flow of the restore process. The restore process is executed by the snapshot control program 215, for example, according to an instruction trigger (restore command) from the server system 102 or the management system 103. The restore command includes a VOL # that identifies the target volume, a VOL # that identifies the restore destination, and a recovery point #.

The set time 702 of the specified recovery point # is acquired from the recovery point management table 224, and the second target time is set (Step S2701). The second target time may be acquired directly from the management system 103.

Next, the snapshot control program 215 acquires the latest SEQ # from the address conversion history table 223 of the target volume and sets the search start SEQ # (Step S2702). This is to process the history information from the new history information to the second target time.

Next, the snapshot control program 215 sets the restore destination based on the VOL # specifying the restore destination included in the restore command (Step S2703). When the SVOL is specified as the restore destination instead of the PVOL, the SVOL is generated and the SVOL address conversion table 222 is prepared.

Next, the snapshot control program 215 refers to the snapshot generation management table 225, and determines whether a snapshot exists for the target volume included in the restore command. If there is no snapshot (Step S2704: NO), the process proceeds to Step S2711. When there is a snapshot (Step S2704: YES), the snapshot generation management table 225 is further referred to, and it is determined whether the snapshot time 804 is newer than the second target time determined in Step S2701.

When the determination result is false (Step S2705: NO), the process proceeds to Step S2711. When the determination result is true (Step S2705: YES), the entries (801 to 806 in FIG. 8) are sequentially acquired from the latest generation # of the snapshot generation management table 225 (Step S2706).

The snapshot time 804 is compared with the second target time (Step S2707), and Steps S2706 and S2707 are repeated until a snapshot whose snapshot time 804 is older than the second target time is found.

When the snapshot having the snapshot time 804 older than the second target time is found, the SEQ #806 of the snapshot one generation newer than the found snapshot is set to the search start SEQ # (Step S2708).

Next, the snapshot control program 215 copies the address conversion table 222 of the snapshot found in Step S2708 to the address conversion table of the restore destination (Step S2709), and executes the common process of FIG. 16 (Step S2710).

If there is no snapshot in Step S2704, or if there are only snapshots older than the target time in Step S2705, the search start SEQ # becomes the latest SEQ # set in Step S2702. In Step S2711, it is determined whether the restore destination is the SVOL. When the restore destination is the SVOL (Step S2711: YES), the contents of the address conversion table 222 of the PVOL are copied to the address conversion table 222 of the SVOL, and the process proceeds to Step S2710.

When the restore destination is the PVOL (Step S2711: NO), the process proceeds to Step S2710.

By performing the process of FIG. 17, it is possible to specify the snapshot immediately after the second target time. By performing the common process from this specified snapshot, the PVOL image at the second target time can be restored at high speed.

According to the disclosed technique, the update of the address conversion history table 223 and the generation of the snapshot are performed asynchronously with the I/O processing for the PVOL 300 (business volume), so that the performance impact on the business volume can be suppressed.

In addition, many recovery points can be created independently of the creation of the snapshot generated by the storage controller 110 and according to the status of the application on the server system 102.

Also, when the recovery point designated by the restore command is restored, the history information to be processed is reduced, so that the restore processing time can be shortened.

As described above, according to the disclosed technology, it is possible to reduce the restore processing time while suppressing the performance influence on the business volume.

What is claimed is:

1. A storage system, comprising:
a controller that provides a business volume to a server system,
wherein the storage system includes
an additional write volume that additionally writes and stores data stored in the business volume, and
wherein the controller is configured to
manage first address conversion information for managing a relationship between a logical address of the business volume and a logical address of the additional write volume, and
an address conversion history information for managing a relationship between a logical address of the business volume and a logical address of the additional write volume for storing old data before the data of the business volume is updated, and managing a time when the data of the business volume is updated as history information,
determine, at each time a data amount of the address conversion history information reaches a predetermined threshold, a first target time indicating a past time point of the business volume, and generate a snapshot of the determined first target time using the address conversion history information,
store, at each time a recovery point set command including a recovery point indicating a restore timing for the business volume is received, a time when the recovery point set command is received together with the recovery point to the address conversion history information, and
restore, when a restore command including information regarding the second target time indicating a restore timing and a restore destination volume for the business volume is received, the business volume using the snapshot of the first target time, the recovery point stored in the address conversion history information, and the address conversion history information.

2. The storage system according to claim 1,
wherein the controller determines whether the first target times of one or more snapshots are newer than the second target time, and
wherein, when there are only snapshots of the first target times that is older than the second target time, the address conversion information of the business volume is copied to second address conversion information of the restore destination volume.

3. The storage system according to claim 2,
wherein the controller is configured to
manage third address conversion information for managing a relationship between a logical address of the snapshot volume and a logical address of the additional write volume for snapshots acquired at a plurality of the first target times, and
copy the third address conversion information of the snapshot generated at the first target time immediately after the second target time in the plurality of the first target times to the second address conversion information of the restore destination volume.

4. The storage system according to claim 2,
wherein the controller is configured to
copy a logical address of the additional write volume indicating a storage location of old data overwritten with update data for the business volume, which corresponds to an update time of the address conversion history information older than the first target time to the second address conversion information of the restore destination volume.

5. The storage system according to claim 2,
wherein the controller is configured to
manage, in the address conversion history information, update order of data for the business volume and order of the recovery point set command as a sequence number.

6. The storage system according to claim 5,
wherein the controller is configured to
manage, in response to receipt of the recovery point set command, recovery point management information for managing a relationship between identification information for uniquely determining a set recovery point, a set time that is set, and the sequence number of the recovery point set command.

7. The storage system according to claim 6,
wherein the controller is configured to
manage, in response to receipt of the recovery point set command, restore point management information for managing a relationship between a logical address of the business volume and a logical address of the additional write volume that stores old data stored in the business volume when receiving the recovery point set command in order to restore data to the business volume when receiving the recovery point set command.

8. The storage system according to claim 6,
the controller is configured to
determine, when a restore command including a recovery point for the business volume is received, the second target time indicating a restore timing based on the recovery point management information.

9. The storage system according to claim 6,
wherein the controller is configured to
store, in a case where a latest update time of the address conversion history information has not reached the second target time, information indicating a storage location of old data corresponding to a next new update time of the address conversion history information to a restore management information as information of a logical address of the additional write volume of the second address conversion information.

10. The storage system according to claim 9,
wherein the controller is configured to
reflect the second address conversion information of the restore destination volume based on the information stored in the restore management information to generate an image of the second target time of the business volume in the restore destination volume.

11. A restore control method for a storage system which includes a business volume, a controller for providing the business volume to a server system, and an additional write volume for additionally writing data stored in the business volume,
wherein the controller is configured to
manage first address conversion information for managing a relationship between a logical address of the business volume and a logical address of the additional write volume, and
an address conversion history information for managing a relationship between a logical address of the business volume and a logical address of the additional write volume for storing old data before the data of the business volume is updated, and managing a time when the data of the business volume is updated as history information,
determine, at each time a data amount of the address conversion history information reaches a predetermined threshold, a first target time indicating a past time point of the business volume, and generate a snapshot of the determined first target time using the address conversion history information,
store, at each time a recovery point set command including a recovery point indicating a restore timing for the business volume is received, a time when the recovery point set command is received together with the recovery point to the address conversion history information, and
restore, when a restore command including information regarding the second target time indicating a restore timing and a restore destination volume for the business volume is received, the business volume using the snapshot of the first target time, the recovery point stored in the address conversion history information, and the address conversion history information.

12. The restore control method according to claim 11,
wherein the controller determines whether the first target time is newer than the second target time, and
wherein, when the first target time is older than the second target time, address conversion information of the business volume is copied to second address conversion information of the restore destination volume.

13. The restore control method according to claim 12,
wherein the controller is configured to
manage third address conversion information for managing the relationship between a logical address of the snapshot volume and a logical address of the additional write volume for snapshots acquired at a plurality of the first target times, and
copy the third address conversion information of the snapshot generated at the first target time immediately after the second target time in the plurality of the first target times to the second address conversion information of the restore destination volume.
